(19) United States
(12) Patent Application Publication
(10) Pub. No.: US 2024/0245571 A1
(43) Pub. Date: Jul. 25, 2024

(54) METHOD AND DEVICE FOR TREATING AMBLYOPIA

(71) Applicant: NOVASIGHT LTD., Airport City (IL)

(72) Inventors: Ran YAM, Jerusalem (IL); Oren YEHEZKEL, Ramat Gan (IL); Dan OZ, Even Yehuda (IL); Tal SAMET, Mazkeret Batya (IL)

(21) Appl. No.: 18/561,310

(22) PCT Filed: May 24, 2022
(86) PCT No.: PCT/IB2022/054823

§ 371 Date: Nov. 16, 2023

Related U.S. Application Data
(60) Provisional application No. 63/192,666, filed on May 25, 2021.

(51) Int. Cl. A61H 5/00; G06T 5/00; G06T 7/20; G06V 10/25; G06V 20/62; G06V 40/16

(52) U.S. Cl. CPC A61H 5/005; G06T 5/00; G06T 7/20; G06V 10/25; A61H 2201/5007; A61H 2201/5043; G06T 2207/10012; G06T 2207/10016; G06V 20/62; G06V 40/161

(57) ABSTRACT

Disclosed are methods and devices suitable for the dichoptic treatment of amblyopia, that in some embodiments comprise concurrently dichoptically displaying two different variants of a received image on a display screen so that each one of the two different variants is visible to only one eye of a subject, an amblyopic-eye image to the amblyopic-eye of a subject and a sighting-eye image to the sighting-eye of a subject, wherein prior to displaying a sighting-eye image, preparing the sighting-eye image for display from a received image by degrading at least a portion of the received image to yield the sighting-eye image having a degraded area which location is determined without reference to a determined gaze direction of a sighting-eye and/or of an amblyopic-eye of a subject.

### RELATED APPLICATION

The present application gains priority from U.S. Provisional Patent Application 63/192,666 filed 25 May 2021, which is included by reference as if fully set-forth herein.

### FIELD AND BACKGROUND OF THE INVENTION

The invention, in some embodiments, relates to the field of ophthalmology and, more particularly but not exclusively, to methods and devices useful for treating amblyopia.

Amblyopia, is a form of cortical visual impairment defined clinically as a unilateral or bilateral reduction of best-corrected visual acuity (BCVA) that cannot be attributed to the effect of structural abnormalities of the eye or ocular disease. In addition to reduced visual acuity, amblyopic subjects may also have dysfunctions of accommodation, fixation, binocularity, vergence, reading fluency, color vision, motion processing and contrast sensitivity. The cause of amblyopia is believed to be a problem that occurred during the critical period in early childhood which problem prevented the visual system from developing normally.

In amblyopia, a person has two physically-functional eyes but the brain does not fuse the two images received from the eyes due to a mismatch between the two images received from the two eyes. There are three primary causes for image mismatch that often occur together and that lead to amblyopia:
strabismus where the lines of sight of the two eyes are misaligned;
visual deprivation where one or both of the eyes is deprived from seeing any functional image; and
refractive amblyopia where the two eyes have unequal refractive power (anisometropia, e.g., myopia and/or hyperopia and/or astigmatism).

Because fusion of the two images cannot be achieved, the visual system of the person selects to use image from the eye that provides the better image which becomes the sighting-eye. The eye that provides the worse image is suppressed and becomes the amblyopic-eye.

Conjugate eye movement (the simultaneous coordinated movement of the two eyes in the same direction) is unaffected so when the sighting-eye is fixated on and follows a moving object, the amblyopic-eye also moves in the same direction and degree without fixation where the deviation angle between the line of sight of the good eye and the line of sight of the amblyopic-eye remains constant.

When a person suffers from severe amblyopia, the portions of the brain used for perceiving images from the amblyopic-eye degenerate so that the amblyopic-eye is not functional even when the sighting-eye is occluded. In a child suffering from light or moderate amblyopia, when both eyes are unoccluded the child's brain ignores the image received from the amblyopic-eye and perceives only the image received from the sighting-eye. However, when only one eye is occluded, the child perceives the image received from whichever eye is not occluded, the sighting-eye or the amblyopic-eye.

As a result, it is critically important to treat children suffering from amblyopia to prevent brain degeneration that leads to vision loss of the amblyopic-eye.

Amblyopia has been classically treated by monocular penalization (e.g., patching, atropine, a Bangerter filter) of the sighting-eye to force the subject to use the amblyopic-eye which use prevents vision loss.

In recent years, amblyopia treatment area has shifted from monocular penalization of the sighting-eye to binocular treatments where both eyes are regularly used. Dichoptic treatments are a subtype of binocular treatment that use dichoptic stimuli, where the two eyes concurrently receive a separate and independent stimuli, the two stimuli selected to reduce the suppression of images received from the amblyopic-eye to a level where the brain simultaneously perceives images received from both eyes. In such a way, the subject simultaneously perceives images from both the sighting-eye and the amblyopic-eye in a way that allows binocular stimulation of vision possibly leading for fusion of the two images received from the two eyes.

US 2020/0329961 to the Applicant and U.S. Pat. No. 10,251,546 to Nottingham University Hospitals NHS Trust both teach methods and devices suitable for the treatment of amblyopia in a subject having an amblyopic-eye and a sighting-eye by degrading an image displayed to the sighting-eye while displaying a different image to the amblyopic-eye so that the amblyopic-eye is used. Both these disclosures rely on using an eye tracker.

### SUMMARY OF THE INVENTION

Some embodiments of the invention herein relate to methods and devices useful in the field of ophthalmology and, in some particular embodiments, useful for the non-invasive dichoptic treatment of amblyopia.

As used herein, the treatment of amblyopia means that application of the method according to the teachings herein (e.g., by using the device of the teachings herein) to an amblyopic subject:
a. reduces the rate of degradation and/or suppression of a subject's visual performance and/or
b. stops degradation and/or suppression of a subject's visual performance and/or
c. reverses degradation and/or suppression of a subject's visual performance thereby improving the subject's visual performance
   which degradation and/or suppression is evidenced by a measurable reduction in the visual acuity of the amblyopic-eye and/or contrast sensitivity of the amblyopic-eye and/or the subject's stereoacuity and/or binocularity.

According to an aspect of some embodiments of the teachings herein, there is provided a device for treating amblyopia in a subject having a sighting-eye and an amblyopic-eye, comprising a computer functionally-associated with an electronic display screen, configured to:
i. receive a digital image;
ii. concurrently dichoptically display two different variants of a received image on the display screen so that each one of the two different variants is visible to only one eye of a subject,
   an amblyopic-eye image to the amblyopic-eye of a subject; and
   a sighting-eye image to the sighting-eye of a subject,
      wherein the computer is further configured to:
prior to displaying an amblyopic-eye image, preparing the amblyopic-eye image for display from a received image; and
prior to the displaying of a sighting-eye image, preparing the sighting-eye image for display from a received image by degrading at least a portion of the received image to yield the sighting-eye image having a degraded area,
   where the computer is configured so that a location of the degraded area is determined without reference to a determined gaze direction of a sighting-eye and/or of an amblyopic-eye of a subject.

In some embodiments, the device is devoid of an eye-tracker for determining a gaze direction of either the sighting-eye or the amblyopic-eye of a subject. In some alternative embodiments, the device comprises an eye-tracker for determining a gaze direction of the sighting-eye and/or the amblyopic-eye of a subject.

In some embodiments, the received image is a still image. In some embodiments, the received image is a frame from a video.

In some embodiments, the amblyopic-eye image and the sighting-eye image constitute a stereoscopic image pair.

In some embodiments, the concurrent displaying is simultaneous display of the amblyopic-eye image and the sighting-eye image on the display screen. Alternatively, in some embodiments, the concurrent displaying is alternatingly displaying the amblyopic-eye image and the sighting-eye image on the display screen at a rate of not less than 24 images per eye per second.

In some embodiments, the device is configured so that the preparing of the amblyopic-eye image for display is such that the amblyopic-eye image is unaltered relative to the received image. In some alternative embodiments, the device is further configured so that the preparing of the amblyopic-eye image for display comprises improving the image quality of at least part of the received image.

In some embodiments, the device is configured so that the preparing of the sighting-eye image from the received image by degrading at least a portion of the received image to yield the sighting-eye image includes reducing the image quality of an area of the received image that corresponds to the degraded area to prepare the sighting-eye image. In some such embodiments, reducing the image quality of the area of the received image that corresponds to the degraded area includes at least one member of the group consisting of: reducing contrast; reduced brightness; blurring; degraded color saturation; limited color pallete; and combinations thereof.

In some embodiments: the display screen is a color screen; the device is configured so that the preparing of the amblyopic-eye image for display is from the blue and green channels of the received image without the red channel of the received image; and the device is configured so that the preparing of the sighting-eye image for display is from the red channel of the received image without the blue and green channels of the received image, so that the amblyopic-eye image and the sighting-eye image constitute an anaglyph image pair.

In some embodiments, the degraded area is at least 50% of the area of a sighting-eye image. In some such embodiments, the degree of image-quality reduction of the degraded area is not more than 90%.

In some alternative embodiments, the degraded area is not more than 50% of the area of a sighting-eye image and is colocated with a predicted area of interest in a received image, and the computer is further configured to prepare a sighting-eye image by:
identifying a predicted area of interest in a received image; and
preparing the sighting-eye image from the received image such that the degraded area is colocated with the predicted area of interest.
   In some such embodiments, the computer is configured so that the balance of the area of the sighting-eye image that is not the degraded area is not-degraded (relative to the corresponding area of the received image).

In some such embodiments, the degraded area that is colocated with a predicted area of interest is a single contiguous degraded area.

Alternately, in some embodiments, the degraded area that is colocated with a predicted area is a non-contiguous degraded area comprising at least two non-contiguous sub-areas separated one from the other. In some such embodiments, two sub-areas are colocated with the same predicted area of interest. Additionally or alternatively, in some such embodiments two sub-areas are each colocated with a different predicted area of interest.

In some such embodiments, the degree of image-quality reduction in at least a portion of a single contiguous degraded area or in at least a portion of one sub-area of the at least two sub-areas is 100%. In some such embodiments, the degree of image-quality reduction in a single contiguous degraded area or in at least one sub-area of the at least two sub-areas is 100%.

In some such embodiments, a received image includes information that designates a portion of the received image as a predicted area of interest and the computer is configured so that identifying an area of interest comprises reading the designating information.

In some embodiments, the computer is configured so that identifying a predicted area of interest comprises at least one member of the group consisting of:
identifying legible text in the received image as as a predicted area of interest;
identifying a face in the received image as as a predicted area of interest;
identifying an outstanding picture element in the received image as a predicted area of interest
identifying an intentional area of interest in the received image as a predicted area of interest; and
identifying an object that is moving in a noteworthy manner as a predicted area of interest.

According to an aspect of some embodiments of the teachings herein, there is also provided a method for treating amblyopia in a subject having a sighting-eye and an amblyopic-eye, the method comprising:
a. receiving, with a computer, a digital image to be displayed to a subject;
b. concurrently dichoptically displaying two different variants of the received image on a single electronic display screen that is functionally-associated with the computer, one variant of the received image to each eye of the subject:
   an amblyopic-eye image to the amblyopic-eye; and
   a sighting-eye image to the sighting-eye,
      wherein:
prior to the displaying of the amblyopic-eye image on the display screen, preparing the amblyopic-eye image for display from the received image; and
prior to the displaying of the sighting-eye image, preparing the sighting-eye image for display from the received image by degrading at least a portion of the received image to yield the sighting-eye image having a degraded area,
   where a location of the degraded area in the sighting-eye image is determined without reference to a determined gaze direction of the sighting-eye and/or of the amblyopic-eye of the subject.

In some embodiments, the received image is a still image. In some embodiments, the received image is a frame from a video.

In some embodiments, the amblyopic-eye image and the sighting-eye image constitute a stereoscopic image pair.

In some embodiments, the concurrent displaying is simultaneous display of the amblyopic-eye image and the sighting-eye image on the display screen. In some alternative embodiments, the concurrent displaying is alternatingly displaying the amblyopic-eye image and the sighting-eye image on the display screen at a rate of not less than 24 images per eye per second.

In some embodiments, preparing the amblyopic-eye image for display is such that the amblyopic-eye image is unaltered relative to the received image. In some alternative embodiments, preparing the amblyopic-eye image for display comprises improving the image quality of at least part of the received image.

In some embodiments, preparing the sighting-eye image from the received image by degrading at least a portion of the received image to yield the sighting-eye image includes reducing the image quality of an area of the received image that corresponds to the degraded area to prepare the sighting-eye image. In some such embodiments, the reducing the image quality of the area of the received image that corresponds to the degraded area includes at least one member of the group consisting of: reducing contrast; reduced brightness; blurring; degraded color saturation; limited color pallete; and combinations thereof.

In some embodiments, the display screen is a color screen; preparing the amblyopic-eye image for display is such that the amblyopic-eye image is prepared from the blue and green channels of the received image without the red channel of the received image; and preparing the sighting-eye image for display is such that the sighting-eye image is prepared from the red channel of the received image without the blue and green channels of that received image, so that the amblyopic-eye image and the sighting-eye image constitute an anaglyph image pair.

In some embodiments, the degraded area of the sighting eye image is at least 50% of the area of the sighting-eye image. In some such embodiments, a degree of image-quality reduction of the degraded area is not more than 90%.

In some embodiments, the degraded area is not more than 50% of the area of the sighting-eye image and is colocated with a predicted area of interest in the received image, and, the preparing of the sighting-eye image for display further comprises:
identifying a predicted area of interest in the received image; and
preparing the sighting-eye image from the received image so that the degraded area is colocated with the predicted area of interest.
   In some such embodiments, the balance of the area of the sighting-eye image that is not the degraded area is not-degraded.

In some such embodiments, the degraded area that is colocated with a predicted area of interest is a single contiguous degraded area.

Alternately, in some embodiments, the degraded area that is colocated with a predicted area is a non-contiguous degraded area comprising at least two non-contiguous sub-areas. In some such embodiments, two sub-areas are colocated with the same predicted area of interest. Additionally or alternatively, in some such embodiments two sub-areas are each colocated with a different predicted area of interest.

In some such embodiments, the degree of image-quality reduction in at least a portion of a single contiguous degraded area or in at least a portion of one sub-area of the at least two sub-areas is 100%. In some such embodiments, the degree of image-quality reduction in a single contiguous degraded area or in at least one sub-area of the at least two sub-areas is 100%.

In some such embodiments, the received image includes information that designates a portion of the received image as a predicted area of interest and the identifying an area of interest comprises reading the designating information.

In some such embodiments, identifying a predicted area of interest comprises at least one member of the group consisting of:
identifying legible text in the received image as as a predicted area of interest;
identifying a face in the received image as as a predicted area of interest;
identifying an outstanding picture element in the received image as a predicted area of interest;
identifying an intentional area of interest in the received image as a predicted area of interest; and
identifying an object that is moving in a noteworthy manner as a predicted area of interest.

According to an aspect of some embodiments of the teachings herein, there is also provided a device for treating amblyopia in a subject having a sighting-eye and an amblyopic-eye, comprising a computer functionally-associated with an electronic display screen, configured to implement an embodiment of the method according to the teachings herein.

### BRIEF DESCRIPTION OF THE FIGURES

Some embodiments of the invention are described herein with reference to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted in the figures are not to scale.

### In the Figures:

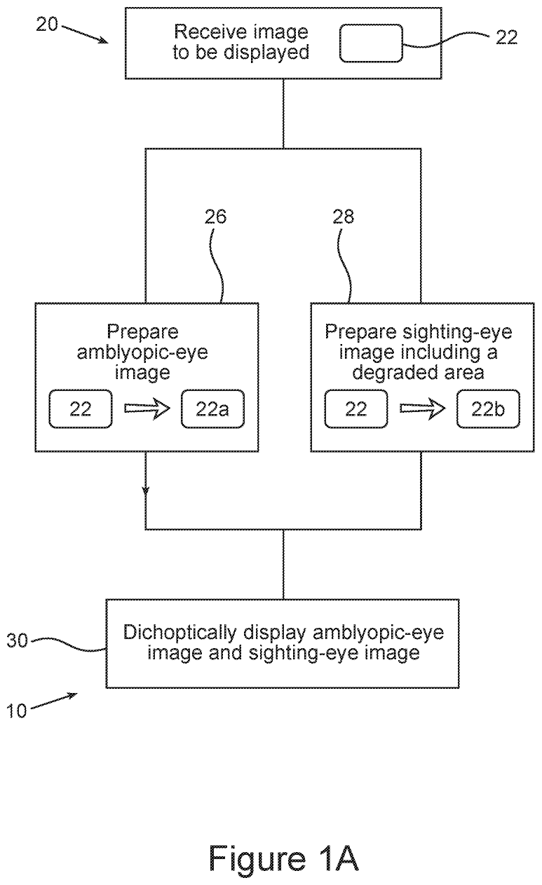

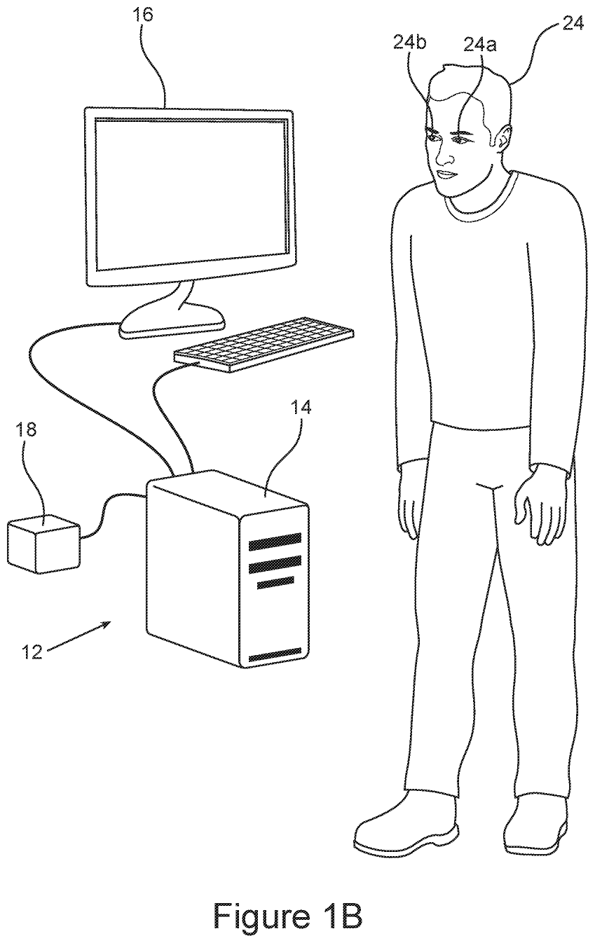

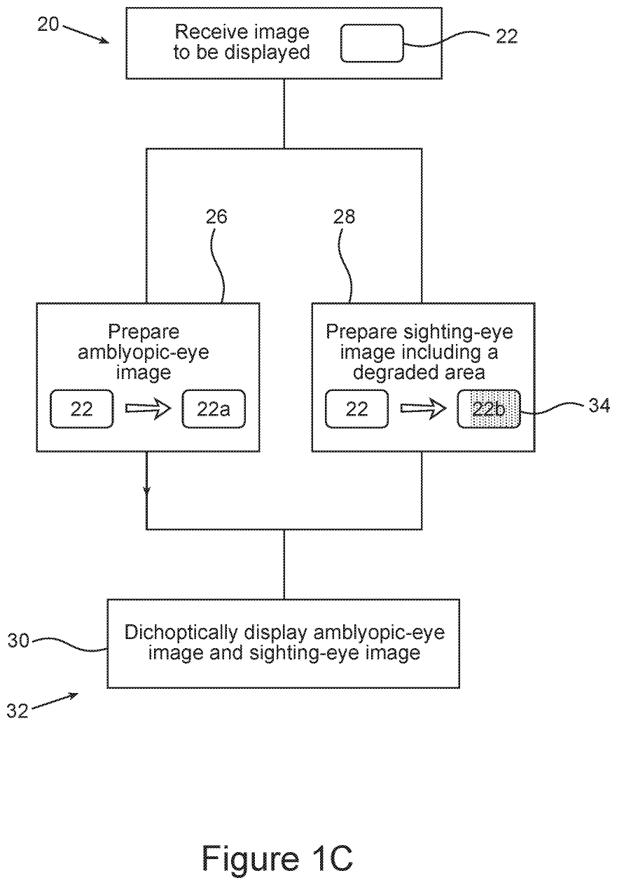

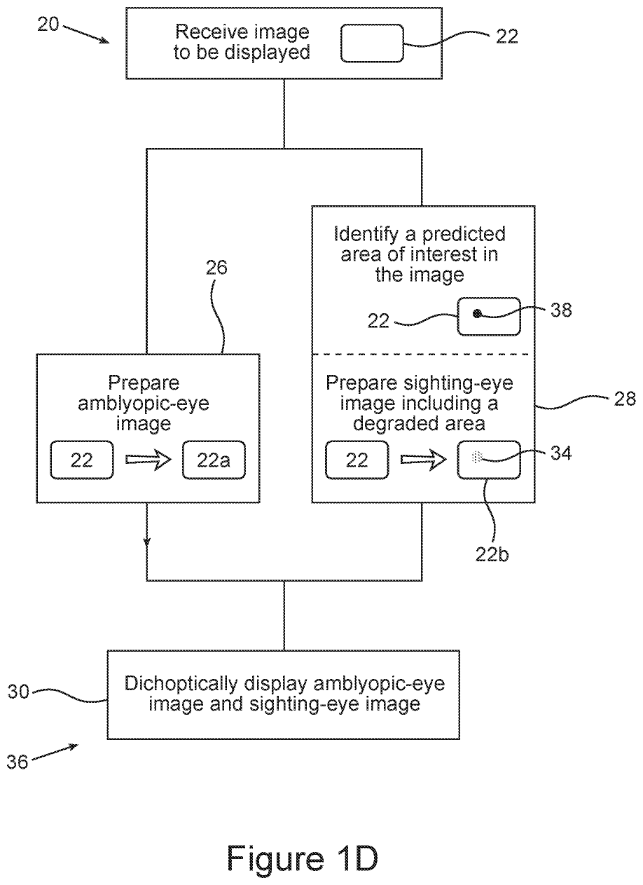

FIG. 1A is a flowchart depicting a general embodiment of the method according to the teachings herein;

FIG. 1B schematically depicts an embodiment of a device suitable for implementing the teachings herein;

FIG. 1C is a flowchart depicting an embodiment of the method according to the teachings herein that does not require identifying a predicted area of interest in a provided image to be displayed;

FIG. 1D is a flowchart depicting an embodiment of the method according to the teachings herein that includes identifying a predicted area of interest in a provided image to be displayed;

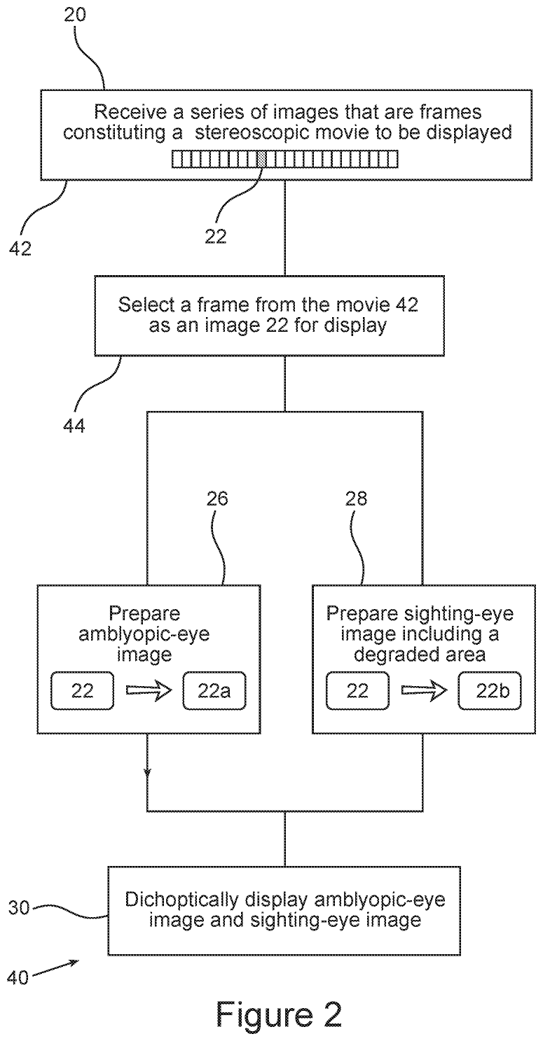

FIG. 2 is a flowchart depicting an embodiment of the method according to the teachings herein implemented to dichoptically display a monoscopic movie to an amblyopic subject;

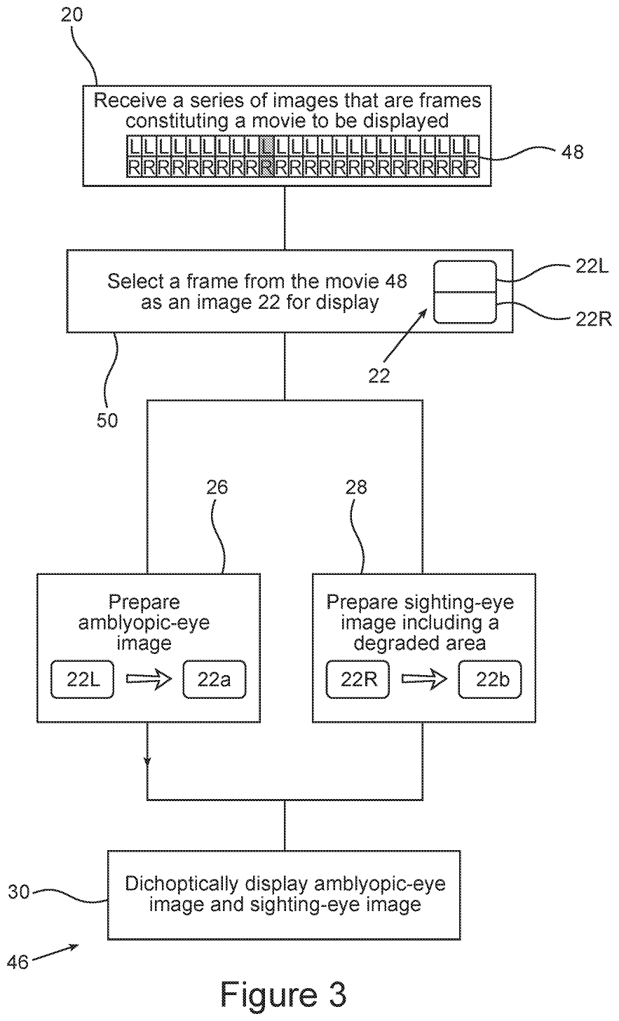

FIG. 3 is a flowchart depicting an embodiment of the method according to the teachings herein implemented to dichoptically display a stereoscopic movie to an amblyopic subject;

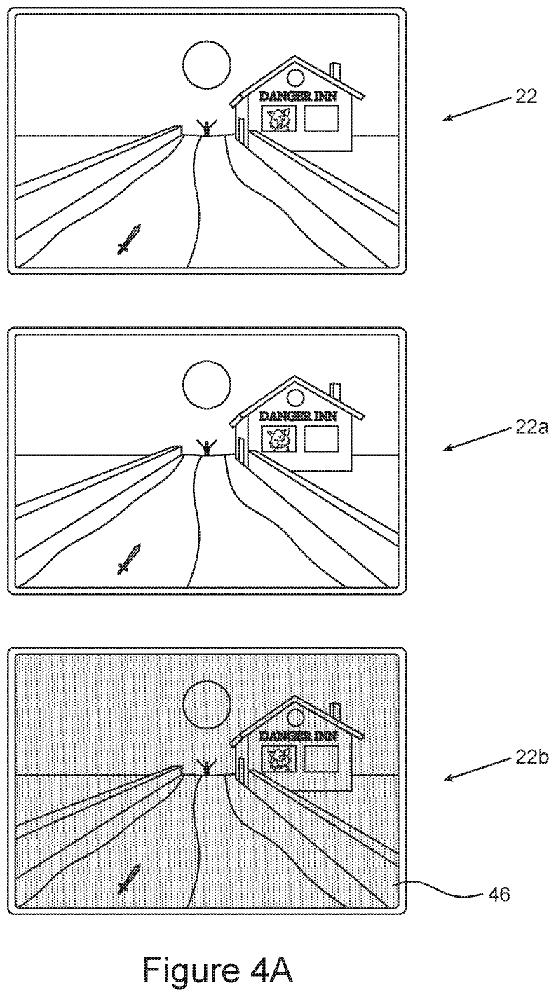

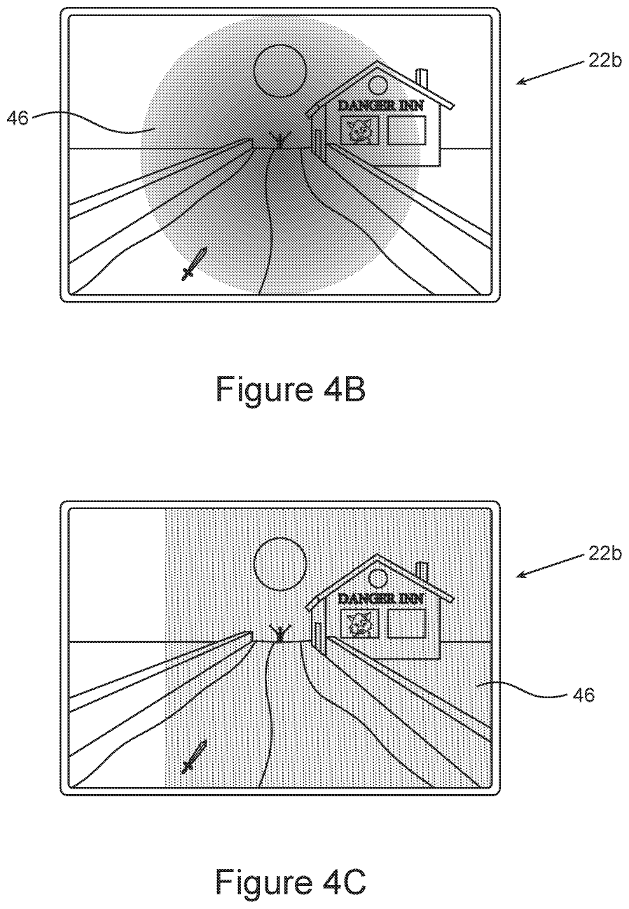

FIG. 4A schematically depicts an exemplary provided image with corresponding amblyopic-eye image and sighting-eye image prepared without necessarily identifying a predicted area of interest in the provided image;

FIGS. 4B and 4C each schematically depict a different exemplary sighting-eye image implemented without necessarily identifying a predicted area of interest in the respective provided image;

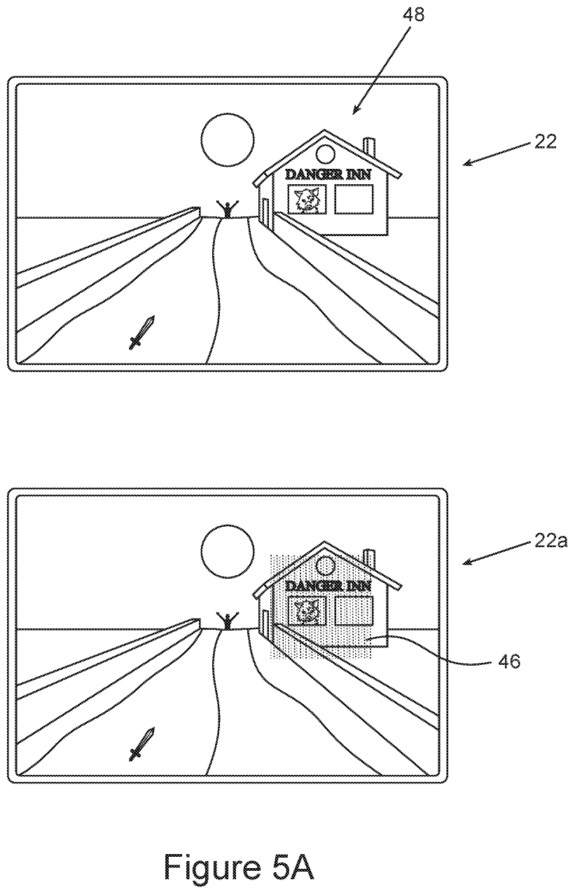

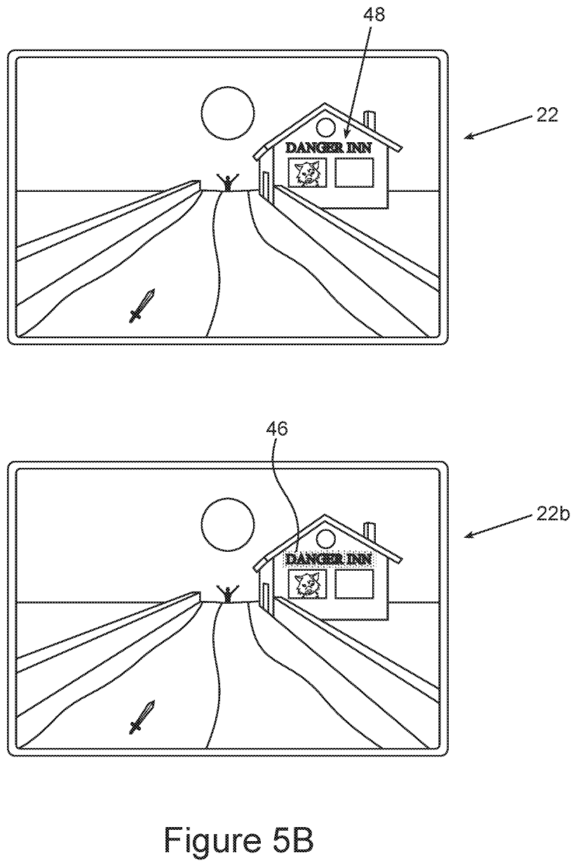

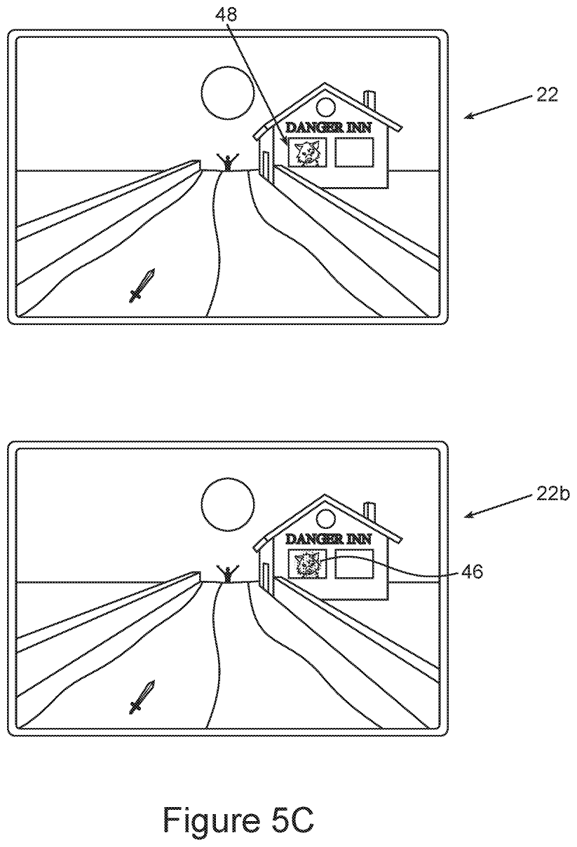

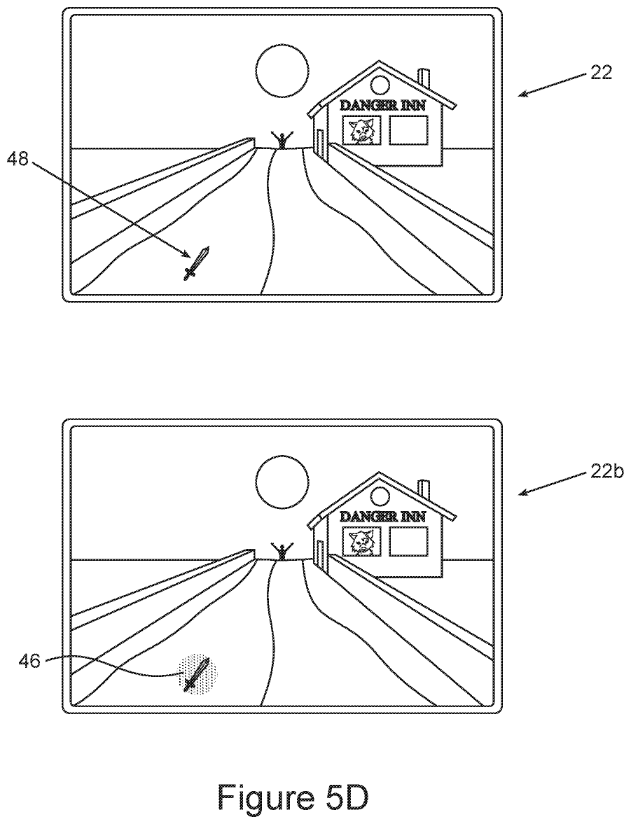

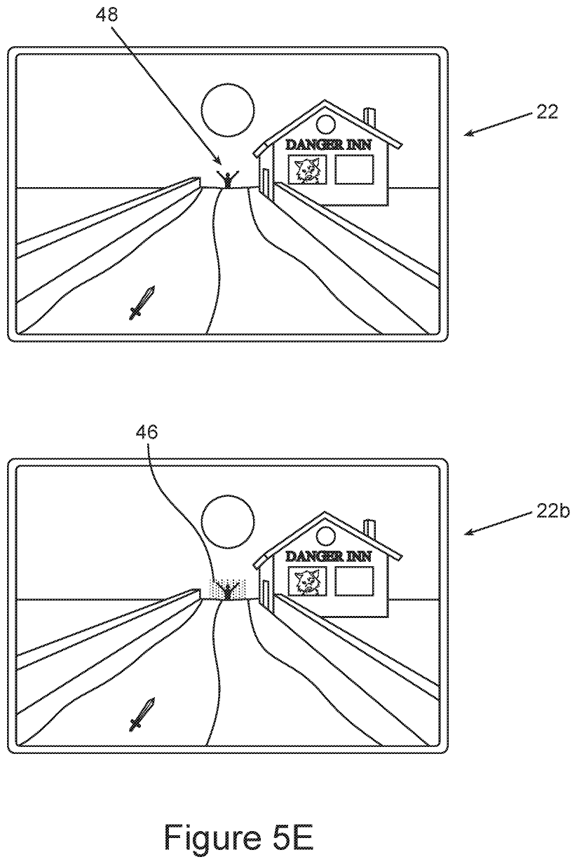

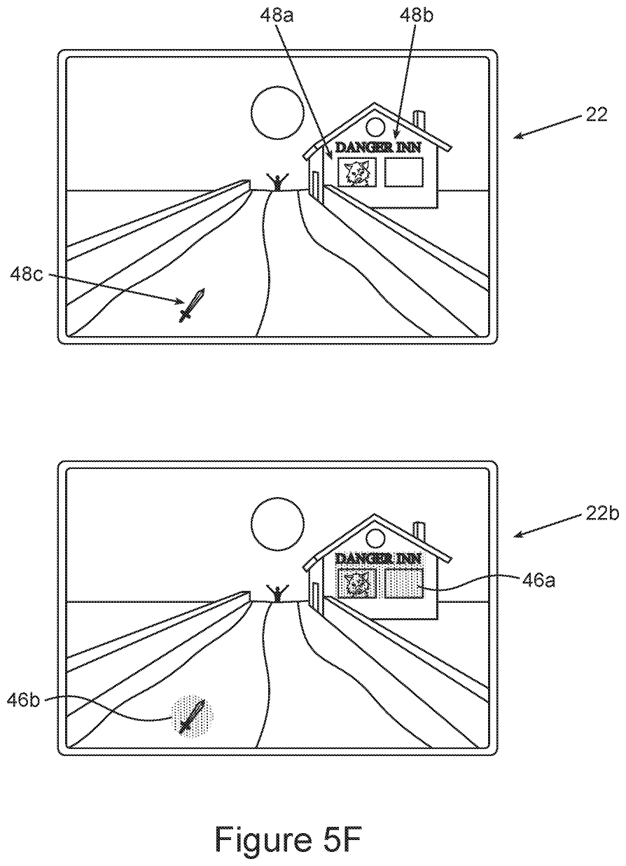

FIGS. 5A-5E each schematically depict a received image and a corresponding sighting-eye image having a degraded areas colocated at an area of interest identified in the received image; and

FIG. 5F schematically depicts a received image and a corresponding sighting-eye image having two degraded areas colocated with area of interests identified in the received image.

### DESCRIPTION OF SOME EMBODIMENTS OF THE INVENTION

Some embodiments of the teachings herein relate to methods and devices useful in the field of ophthalmology and, in some particular embodiments, useful for the non-invasive dichoptic treatment of amblyopia.

The principles, uses and implementations of the teachings of the invention may be better understood with reference to the accompanying description and figures. Upon perusal of the description and figures present herein, one skilled in the art is able to implement the teachings of the invention without undue effort or experimentation. In the figures, like reference numerals refer to like parts throughout.

Before explaining at least one embodiment of the invention in detail, it is to be understood that the invention is not necessarily limited in its application to the details of construction and the arrangement of the components and/or methods set forth herein. The invention is capable of other embodiments or of being practiced or carried out in various ways. The phraseology and terminology employed herein are for descriptive purpose and should not be regarded as limiting.

As discussed in the introduction, untreated amblyopia leads to degradation and/or suppression of visual performance due to interocular suppression of the amblyopic-eye due to interocular suppression of the amblyopic-eye. As used herein, “visual performance” includes one or more of visual acuity, contrast sensitivity, stereoacuity and binocularity.

US 2020/0329961 to the Applicant and U.S. Pat. No. 10,251,546 to Nottingham University Hospitals NHS Trust both teach methods and devices suitable for the dichoptic treatment of amblyopia in a subject having an amblyopic-eye and a sighting-eye by degrading an image displayed to the sighting-eye while displaying a different image to the amblyopic-eye so that the amblyopic-eye is used. Both these disclosures rely on using an eye tracker.

Herein are disclosed methods and devices for the non-invasive dichoptic treatment of amblyopia that do not require the use of any eye tracker. In some embodiments, such methods and devices are technically simpler, cheaper and easier to implement than known in the art. In some embodiments, such methods and devices are suitable for widespread treatment of subjects suffering from amblyopia in a non-clinical setting, e.g., at home or at school. In some preferred embodiments, the teachings are suitable for treating a subject who is viewing at standard generally-available digital content that is not custom-made for implementing the teachings herein. In some embodiments, the teachings are implemented in day-to-day settings, for example, when the subject is playing a video game, when the subject is watching content from the Internet or watching video entertainment.

The methods and devices of the teachings herein receive an image and dichoptically display the image to a subject having amblyopia in a way to treat the amblyopia. The teachings herein and embodiments thereof are discussed in detail hereinbelow with reference to the figures.

According to an aspect of some embodiments of the teachings herein, there is provided a method for treating amblyopia in a subject having a sighting-eye and an amblyopic-eye, the method comprising:
a. receiving, with a computer, a digital image to be displayed to a subject;
b. concurrently dichoptically displaying two different variants of the received image on a single electronic display screen that is functionally-associated with the computer (so that the subject can see the two displayed variants), one variant of the received image to each eye of the subject:
   an amblyopic-eye image to the amblyopic-eye; and
   a sighting-eye image to the sighting-eye,
      wherein:
prior to the displaying of the amblyopic-eye image on the display screen, preparing the amblyopic-eye image for display from the received image; and
prior to the displaying of the sighting-eye image, preparing the sighting-eye image for display from the received image by degrading at least a portion of the received image to yield the sighting-eye image having a degraded area,
   where a location of the degraded area in the sighting-eye image is determined without reference to a determined gaze direction of the sighting-eye and/or of the amblyopic-eye of the subject.

In FIG. 1A a flowchart 10 depicting a general embodiment of the method.

In FIG. 1B, an embodiment of a device suitable for implementing the teachings herein is schematically depicted, device 12 comprising a computer 14 with a display screen 16 and a wireless modem 18 with which to communicate with the Internet in the usual way. Computer 14, display screen 16 and modem 18 are standard commercially-available general-purpose components but computer 14 is software configured to implement embodiments of the teachings herein.

With simultaneous reference to flowchart 10 in FIG. 1A and device 12 depicted in FIG. 1B, in a box 20, a digital image 22 to be displayed to a subject 24 having amblyopia is received by computer 14 as an image data file from the Internet.

In a box 26 of FIG. 1A, an amblyopic-eye image 22a for display to the amblyopic-eye 24a of subject 24 is prepared.

In a box 28 of FIG. 1A, a sighting-eye image 22b for display to sighting-eye 24b of subject 24 is prepared, where sighting-eye image 22b includes a degraded area. Preparation of sighting-eye image 24b is performed without reference to a measured gaze direction of either amblyopic-eye 24a and/or sighting eye 24b.

In a box 30 of FIG. 1A, the two variant images 22a and 22b are concurrently dichoptically displayed to subject 24: amblyopic-eye image 22a to amblyopic-eye 24a and sighting-eye image 22b to sighting-eye 24b. Subject 24 views the image pair (sighting-eye image 22b and amblyopic-eye image 22a) in the usual way with both eyes, and may or may not be aware of the degraded area of sighting-eye image 24b.

In some preferred embodiments, the degraded area is at least 50% of the sighting-eye image. In FIG. 1C is a flowchart 32 depicting such an embodiment of the method where a degraded area 34 is at least 50% of sighting-eye image 22b. Such embodiments preferably, but not necessarily, do not require identifying a predicted area of interest and are discussed in greater detail with reference to FIG. 4.

In some alternate preferred embodiments, the degraded area is colocated with a predicted area of interest identified in the received image. FIG. 1D is a flowchart 36 depicting such a embodiment of the method where a degraded area 34 is colocated with an identified predicted area of interest 38. Such embodiments are discussed in greater detail with reference to FIG. 5. With specific reference to flowchart 36 in FIG. 1D, in box 28, a predicted area of interest 38 is identified in received image 22 and sighting-eye image 22b is prepared where, in sighting-eye image 22b, degraded area 34 is colocated with the identified predicted area of interest 38 in received image 22.

The degree and type of image-quality reduction in the degraded area of the sighting-eye image are such that the subject's brain usually (but not necessarily 100% of the time) perceives the image received from the amblyopic-eye. Preferably, during times when the subject's brain perceives the image received from the amblyopic-eye, the subject's brain simultaneously perceives images received from both the amblyopic-eye and the sighting-eye allowing fusion of the two perceived images.

Perception by the subject's visual system of images received from the amblyopic-eye treats the amblyopia as relates to one or both the visual acuity and contrast sensitivity of the amblyopic eye, as defined hereinabove in the Summary of Invention.

Perception by the subject's visual system of images concurrently received from both the amblyopic-eye and from the sighting-eye treats the amblyopia as relates to one or both of stereoacuity of the subject's vision and binocularity of the subject's vision as defined hereinabove in the Summary of Invention.

### Hardware

As noted above, the method is implemented using hardware that includes a single electronic display screen (16 in FIG. 1B) functionally-associated with a computer (14 in FIG. 1B), the display screen configured to be visible to both eyes of a subject being treated.

Thus, according to an aspect of some embodiments of the teachings herein, there is also provided a device for treating amblyopia in a subject having a sighting-eye and an amblyopic-eye, comprising a computer functionally-associated with an electronic display screen, configured to:
i. receive a digital image;
ii. concurrently dichoptically display two different variants of a received image on the display screen so that each one of the two different variants is visible to only one eye of a subject,
   an amblyopic-eye image to the amblyopic-eye of a subject; and
   a sighting-eye image to the sighting-eye of a subject,
      wherein the computer is further configured to:
prior to displaying an amblyopic-eye image, preparing the amblyopic-eye image for display from a received image; and
prior to the displaying of a sighting-eye image, preparing the sighting-eye image for display from a received image by degrading at least a portion of the received image to yield the sighting-eye image having a degraded area,
   where the computer is configured so that a location of the degraded area is determined without reference to a determined gaze direction of a sighting-eye and/or of an amblyopic-eye of a subject.

Any suitable computer with any suitable functionally-associated screen may be used including screens with a flat surface and screens with a curved surface. The configuration of a computer to implement the teachings herein includes appropriate software, hardware, firmware and combinations thereof. A person having ordinary skill in the art of computer programming is able to to implement the teachings herein without undue experimentation upon perusal of the description herein.

In some embodiments, the device is devoid of an eye-tracker for determining the gaze direction of either the sighting-eye or the amblyopic-eye of a subject. For example, device 12 depicted in FIG. 1B is devoid of an eye-tracker. In some alternate embodiments, the device comprises an eye-tracker for determining a gaze direction of the sighting-eye and/or the amblyopic-eye of a subject, but a gaze direction of the sighting-eye and/or of the amblyopic-eye determined by the eye tracker is not used to determine the location of the degraded area in the sighting-eye image. For example, in some embodiments, an eye-tracker is used to monitor the progress of the treatment of a subject, to monitor the efficacy of the degradation of the sighting-eye image or to monitor a subject's compliance.

Any technology of electronic display screen that is suitable for the display of digital images may be used to implement the method and/or device of the teachings herein including LCD and LED technology. In some embodiment, a display screen for implementing autostereoscopy (glasses-free 3D) is used. For example, display screen 16 depicted in FIG. 1B is configured for implementing autostereoscopy.

In some preferred embodiments the screen is a color screen. In some alternate embodiments, the screen is a monochrome screen or a grey-scale screen.

The size of the screen is any suitable size and is usually dependent on the distance from the screen which the subject is expected to be located during treatment. In some embodiments, the screen is not less than 8″ diagonal, not less than 10″ diagonal and even not less than 14″ diagonal.

The aspect ratio of the screen is any suitable aspect ratio, for example, 5:4, 4:3, 16:10 and 16:9.

The pixel density of the screen is any suitable pixel density, typically not less than 100 PPI (pixels per square inch).

The computer used for implementing the method and/or device is any suitable computer that has sufficient processor speed and memory and peripheral hardware to implement the teachings herein.

Suitable display screen and computer combinations that are suitable for implementing the method and/or device of the teachings herein include smartphones (e.g., Galaxy s9 from Samsung, Seocho District, Seoul, South Korea), tablet computers (e.g., iPad 10.2 from Apple Cupertino, California, USA), laptop computers (e.g., Tecra Z50-D-11G from Toshiba, Minato City, Tokyo, Japan) and desktop computers (e.g., OptiPlex 7080 Micro OP7080-6110 computer with a S2721DGFA monitor, both from Dell, Round Rock, Texas, USA).

### Received Image

The received image (22 in FIG. 1) is any suitable digital image and is received in any suitable way.

In some embodiments, the received image is a still image, e.g., a page of text, a picture, graphic patterns/shapes and combinations thereof.

In some embodiments, the received image is a frame from a video, e.g., real video images, animation images, graphic patterns/shapes and combinations thereof. Typically, when a frame of a video is received, the frame is received together with multiple additional frames that make up the video. For example, when a subject desires to watch a streaming movie from the Internet, the computer receives the entire video comprising a series of many individual frames, so that the individual frames are the received images according to the teachings herein. An embodiment of receiving an image that is a frame of a video is schematically depicted in FIG. 2 in a flowchart 40. In a box 20, a movie 42 is received, movie 42 comprising a series of frames, each frame being an image. In a box 44, a frame from movie 42 is selected as image 22 for further processing in accordance with the teachings herein. As known in the art, a movie is downloaded (e.g., via a modem 18) or accessed from a storage device (e.g., a hard disk, solid-state storage device, CD, DVD, laser disk) in the usual way, comprising a series of frames to be consecutively displayed, each frame constituting an individual image to be displayed. As is known in the art, in some embodiments the entire movie including all the frames is downloaded and stored locally and in some embodiments the movie is downloaded portionwise, each portion comprising some but not all of the frames of the movie.

In some embodiments, the received image is an entire image file that is to be displayed on the display screen. In some embodiments, the received image is a portion of an image file and only a portion of the image file is to be displayed, e.g., the entire image is magnified or scrolled so that only a portion of the entire image file is actually displayed on the screen.

The received image is received from any suitable source. In preferred embodiments, the received image is an image that is configured for display on an electronic display in the usual way, e.g., a remotely-stored image (for example, from the Internet, a remote server, or a Cloud received by the computer in any suitable way, e.g. by LAN or wireless transmission such as WiFi or mobile telecommunication standards such as 2G, 2.5G, 2.75G, 3G, 3.5G, 3.75G. 3.9G, 3.95G, 4G, 4.5G, 4.9G, 5G and 6G) or a locally-stored image (e.g., an image such as an individual frame) from a video game, movie or e-book stored on local storage media such as a hard disk, solid state storage device or laser disk functionally associated with the computer). In some such embodiments, some or all of a received image is provided in real time by a video camera (e.g., live video, optionally with augmented reality content). In some embodiments, the received image is an arbitrary image, that is to say, an image that is devoid of specific data for implementing the teachings herein. In some alternate embodiments, the received image is a custom image configured for implementing the teachings herein. Such embodiments are discussed in greater detail hereinbelow.

In some embodiments, the received image is a monoscopic image as depicted in FIGS. 1A, 1C, 1D and 2. In such embodiments, both the amblyopic-eye image 22a and the sighting-eye image 22b are prepared from the same received monoscopic image 22. In such embodiments, the amblyopic-eye image 22a and the sighting-eye image 22b are not a stereoscopic image pair.

Alternatively, in some embodiments, the received image is a stereoscopic image pair (i.e., the received image comprises a left-eye image and a right-eye image). In such embodiments, the amblyopic-eye image and the sighting-eye image are each prepared from the corresponding eye image: if the amblyopic-eye is the right eye, the amblyopic-eye image is prepared from the right-eye image and the sighting-eye image is prepared from the left eye image while if the amblyopic-eye is the left eye, the amblyopic-eye image is prepared from the left-eye image and the sighting-eye image is prepared from the right-eye image. In such embodiments, the sighting-eye image and the amblyopic-eye image constitute a stereoscopic image pair. An embodiment of receiving an image that is a stereoscopic image pair is schematically depicted in FIG. 3 in a flowchart 46. In a box 20, a stereoscopic movie 48 is received, stereoscopic movie 48 comprising a series of stereoscopic frames, each stereoscopic frame being a stereoscopic image pair having a left-eye image and a right-eye image. In a box 50, a frame from movie 48 is selected as stereoscopic image 22, comprising a left-eye image 22L and a right-eye image 22R. In the specific embodiment, the left eye of the subject is the amblyopic eye so that in box 26, an amblyopic-eye image 22a is prepared for display from left-eye image 22L of received image 22. In the specific embodiment, the right eye of the subject is the sighting eye so that in box 28, a sighting-eye image 22b is prepared for display from right-eye image 22R of received image 22.

### Concurrent Dichoptic Display

As noted above, the two different variants of the received image are concurrently dichoptically displayed to the subject on a single electronic display screen that is functionally-associated with a computer, one variant of the received image to each eye: an amblyopic-eye image to the amblyopic-eye; and a sighting-eye image to the sighting-eye.

In some embodiments, the concurrent displaying is simultaneous displaying, that is to say, the amblyopic-eye image and the sighting-eye image are simultaneously displayed on the single display screen. In some such embodiments, the sighting-eye image and the amblyopic-eye image constitute an anaglyph pair of images and a subject being treated is required to wear anaglyph glasses to ensure that the amblyopic-eye sees only the amblyopic-eye image and that the sighting-eye sees only the sighting-eye image. In some such embodiments, the sighting-eye image and the amblyopic-eye image are perpendicularly polarized and a person being treated is required to wear polarized 3D-glasses to ensure that the amblyopic-eye sees only the amblyopic-eye image and that the sighting-eye sees only the sighting-eye image. In some embodiments, the display screen is configured for implementing autostereoscopy thereby allowing glasses-free simultaneous display of a different image to each eye of the subject as is known in the field of autostereoscopic display screens (e.g., the commercially-available 55ZL2 from Toshiba).

In some embodiments, the concurrent displaying is alternatingly displaying the sighting-eye image and the amblyopic-eye image on the display screen to the subject at a rate of not less than 24 images per eye per second (image-pair cycles per second) and the alternate displaying is coordinated with a pair of active-shutter glasses that a subject being treated is required to wear. As is known to a person having ordinary skill in the art, such coordination includes that when the amblyopic-eye image is displayed on the display screen, the lens of the active shutter glasses that is located in front of the amblyopic-eye is set to transparent and the lens located in front of the sighting-eye is set to opaque and when the sighting-eye image 5 is displayed on the display screen, the lens of the active shutter glasses that is located in front of the amblyopic-eye is set to opaque and the lens located in front of the sighting-eye is set to transparent. In such a way, the amblyopic-eye sees only amblyopic-eye images and the sighting-eye sees only sighting-eye images. Although 24 image pair cycles per second is considered the slowest rate that provides acceptable results, higher rates are preferred, e.g., not less than 30, not less than 40 and even not less than 60 image pair cycles per second.

### Amblyopic-Eye Image

As noted above, prior to the displaying of the amblyopic-eye image, the amblyopic-eye image is prepared from the received image. Preferably, such preparing is performed locally by the device (e.g., the computer and/or display screen).

As the received digital image is a digital image data file, preparation of the amblyopic-eye image for display includes the usual standard processing for concurrent display of the amblyopic-eye image and the sighting-eye image on the display screen (e.g., to account for the display screen technology, technical parameters of the screen, and whether concurrent display is simultaneous or alternating). Optional additional preparation includes magnification of the image so that only a portion of the received image is displayed on the screen at one time (e.g., to make text or image details clearer), rotation, tilting or scrolling (e.g., to allow a certain portion of a lengthy text to be displayed on the screen).

In some embodiments, the quality of the amblyopic-eye image is unaltered relative to the received image so that no preparation that is unique to the teachings herein is performed to prepare amblyopic-eye image from the received image, rather only the usual preparation required to display an image on the available screen is performed. Specifically, in some such embodiments where the received image is monoscopic, the amblyopic-eye image appears identical to how the received image would have been displayed without application of the teachings herein. In some such embodiments where the received image is stereoscopic, when the amblyopic-eye is the right eye, the amblyopic-eye image appears identical to how the received right-eye image would have been displayed without application of the teachings herein, and when the amblyopic-eye is the left eye, the amblyopic-eye image appears identical to how the received left-eye image would have been displayed without application of the teachings herein.

In some alternate embodiments, the quality of the amblyopic-eye is improved relative to the received image. Improvement of the quality of the received image to prepare the amblyopic-eye image can include one or more of: increasing contrast, increasing brightness, sharpening and improving saturation. Such image-improvement and methods of performing such image-improvement are well-known in the art.

### Sighting-Eye Image

As noted above, prior to the displaying of the sighting-eye image, the sighting-eye image is prepared from the received image. In preferred embodiments, such preparing is performed locally by the device (e.g., the computer and/or display screen). Similar to the discussed with reference to the amblyopic-eye image, preparation of the sighting-eye image for display includes the usual standard processing for concurrent display of the amblyopic-eye image and the sighting-eye image on the display screen. Typically, preparation that includes magnification, rotation, tilting or scrolling of the image is performed the same for both the sighting-eye image and the amblyopic-eye image.

As noted above, part of the preparation of the sighting-eye image according to the teachings herein is degrading at least a portion of the received image to yield the sighting-eye image having a degraded area, where the location of the portion of the received image that is degraded to yield the sighting-eye image is determined without reference to a measured gaze direction of the sighting-eye and/or of the amblyopic-eye of the subject.

### Degree and Type of Degradation

As noted above, in preferred embodiments the degree and type of degradation of the sighting-eye image are such that when the subject looks at the degraded area in the sighting-eye image with the sighting eye and the corresponding area in the amblyopic-eye image with the amblyopic eye, the subject's visual system preferably perceives the image received from the amblyopic-eye and, more preferably, simultaneously perceives the images received from both the amblyopic-eye and the sighting-eye allowing fusion of the two images.

The type of degradation of the sighting-eye image is any suitable type or combination of types of image-degradation so that compared to the corresponding area of the received image, the degraded area of the sighting-eye image is degraded.

In some embodiments of the method, preparing the sighting-eye image from the received image to yield the sighting-eye image includes reducing the image quality of an area of the received image that corresponds to the degraded area.

Further, in some embodiments, the device of the teachings herein is configured so that the preparing of the sighting-eye image from the received image to yield the sighting-eye image includes reducing the image quality of an area of the received image that corresponds to the degraded area.

In some such embodiments, reducing the image quality of the area of the received image that corresponds to the degraded area includes at least one member of the group consisting of:
reducing contrast (so that the degraded area has reduced contrast compared to the corresponding area in the sighting-eye image);
reduced brightness (so that the degraded area is less bright compared to the corresponding area in the sighting-eye image);
blurring (so that the degraded area is more blurred and less sharp compared to the corresponding area in the sighting-eye image);
degraded color saturation (so that the color saturation of the degraded area is degraded compared to the corresponding area in the sighting-eye image);
limited color pallete (so that the color palette of the degraded area is limited compared to the corresponding area in the sighting-eye image); and
combinations thereof.

In most embodiments (e.g., polarized display, alternating display, autostereoscopic display), any suitable type or combination of types of image-degradation may be used for reducing the image quality of an area of the received image that corresponds to the degraded area

In embodiments where the teachings herein are implemented using anaglyph methods: the display screen is a color screen (RGB); the amblyopic-eye image is prepared from the blue and green channels of the received image without the red channel; and the sighting-eye image is prepared from the red channel of the received image without the blue and green channels; so that the amblyopic-eye image and the sighting-eye image constitute an anaglyph image pair. A subject being treated in such embodiments wears anaglyph glasses configured such that the amblyopic-eye only perceives the blue and green pixels of an image displayed on the display screen and the sighting-eye only perceives the red pixels of an image displayed on the display screen. In some such embodiments, preparation of the amblyopic-eye image is no more than standard display of the blue and green channels of the received image on the display. In such embodiments, the sighting-eye image is prepared from the red channel of the received image without the blue and green channels. In such embodiments, some type of image degradation (e.g., decreasing contrast; reducing brightness; blurring; and degrading color saturation) is applied to the portion of the red channel of the received image that corresponds to the degraded area of the sighting-eye image to prepare the sighting-eye image from the red channel of the received image.

The degree of image-quality reduction is any suitable degree and is dependent, inter alia, on which specific type or types of image-quality reduction is used and the decision of a person (e.g., health care professional) who is implementing the teachings herein that is typically based also on the severity of the condition that causes a specific subject to suffer from amblyopia.

In some embodiments, the image-quality reduction is at least 5%, i.e., the image-quality of the degraded area is at least 5% less than of the corresponding area in the received image. For example, in such embodiments where the contrast of the degraded area is reduced, the contrast in the degraded area is only 5% less than of the corresponding area in the received image.

Additionally, in some embodiments, the image-quality reduction is not more than 95%, i.e., the image-quality of the degraded area is not less than 5% of the image quality of the corresponding area in the received image. For example, in such embodiments where the contrast of the degraded area is reduced, the contrast in the degraded area is only 5% of the contrast in the corresponding area in the received image.

In some embodiments, a desired degree and/or type of image-quality reduction is determined (e.g., by a health care professional who has tested the vision of the subject) and entered as a parameter for preparing the sighting-eye image.

In some such embodiments, the degree and/or type of image-quality reduction is a constant and is optionally periodically changed, for example, under direction of a health care professional who periodically monitors the subject's vision. Specifically, the subject's vision is periodically monitored and improvement of the vision (e.g., resulting by the use of the teachings herein) allows the health care professional to choose to reduce the degree of image-quality reduction while deterioration of the subject's vision allows the health care professional to choose to increase of the degree of image-quality reduction or to change the type of image-quality reduction.

In some alternative such embodiments, the degree of image-quality reduction is not constant, rather changes at a pre-determined rate or according to a predetermined schedule. For example, in some embodiments, an initial desired degree of image-quality reduction is set as described above and the degree of image-quality reduction is reduced by 1% each session.

### Non-Localized Degradation of the Received Image

In a first preferred embodiment, the degraded area is a majority of the area of the sighting-eye image (at least 50%), see flowchart 32 in FIG. 1C. Such embodiments are advantageous as being simple to implement and having only modest processing-power requirements.

In such embodiments, the degree of image-quality reduction relative to the corresponding area in the received image is not more than 90% so that the sighting-eye image always contains some visual information that can be perceived by the sighting-eye.

In some embodiments, the degraded area of the sighting-eye image is at least 50% of the area of the image, at least 60%, at least 70%, at least 80% and even at least 90%. In some such embodiments, the degraded area is not more than 95% of the sighting-eye image. Alternatively, in some such embodiments the degraded area is greater than 95%, even the entire sighting-eye image.

In some embodiments, the degraded area is a single contiguous degraded area. In some embodiments, the degraded area comprises at least two non-contiguous sub-areas.

In embodiments where the degraded area is smaller than the entire sighting-eye image, the degraded area is located anywhere on the display screen, in some embodiments in the center of the display screen. In some alternate embodiments where the degraded area is smaller than the entire sighting-eye image, the degraded area is located off-center of the display screen. In some embodiments, for at least some pairs of sighting-eye images that are successively displayed, the center of the degraded area is different. In some such embodiments, the location of the center of a sighting-eye images changes randomly. In some such embodiments, the centers of two consecutive different sighting-eye images change in a predetermined pattern.

The shape of the degraded area is any suitable shape, e.g., round, oval, square, rectangular, star-shaped and even of an irregular shape.

In some embodiments, the degraded area has a uniform degree of image-quality reduction (homogeneous degradation). In some embodiments, there is a variation in degree of image-quality reduction (heterogeneously degradation), for example, greater degree of image-quality reduction near the center of the degraded area and a lesser degree of image-quality reduction near the periphery of the degraded area. In some embodiments, the degree of image-quality reduction is a gradient that is less near the periphery of the degraded area and increases away from the periphery of the degraded area.

Exemplary embodiments of such an embodiment are schematically depicted in FIGS. 4A, 4B and 4C where the degraded area is schematically depicted as a grey overlay.

In FIG. 4A, a received image 22, a corresponding amblyopic-eye image 22a and a corresponding sighting-eye image is 22b appear if displayed. Amblyopic-eye image 22a is identical to received image 22. Sighting-eye image 44 includes a homogeneous degraded area 46 that makes up the entire sighting-eye image

In FIG. 4B, a sighting-eye image 22b is displayed, including a circular degraded area 46 centered in image 22b, degraded area 46 making up 70% of the area of image 22b. Area 46 is heterogeneously degraded, with a greater degree of image-quality reduction in the center than in the periphery, the degree of image-quality reduction being a gradient.

In FIG. 4C, a sighting-eye image 22b is displayed, including a rectangular degraded area 46 centered in image 22b, degraded area 46 making up 70% of the area of image 22b. Area 46 is homogeneously degraded.

Degradation Colocated with a Predicted Area of Interest

In some embodiments, the degraded area is a minority of the area of the sighting-eye image (not more than 50%) that is colocated with a predicted area of interest. A predicted area of interest in the sighting-eye image is a portion of the sighting-eye image that corresponds to a portion of the the received image that is predicted to draw the gaze of a subject and to be viewed with the subject's central vision.

Compared to the previously-discussed embodiment, such embodiments may require more processing-power to implement but an advantage is that a greater portion of the sighting-eye image is not-degraded because the degraded area is smaller. Without being held to any one theory, it is currently believed that in such embodiments, when the subject looks at the predicted area of interest the subject's visual system perceives the predicted area of interest with the central vision of the amblyopic-eye and in some instances perceives the predicted area of interest with the central vision of both the amblyopic-eye and of the sighting-eye. At the same time, the subject's visual system perceives the areas around the predicted area of interest that are not degraded in the sighting-eye image with the peripheral vision of the amblyopic-eye and in some instances perceives it with the peripheral vision of both the amblyopic-eye and of the sighting-eye.

It is recognized that in some moments of a treatment session, the subject does not look at the predicted area of interest but that the central vision of the subject is directed at something else in the displayed images. During such moments, the subject's visual system perceives the central portion of the sighting-eye image received from the sighting-eye without degradation because the degraded area that is colocated with the predicted area of interest is in the periphery of the image received from the sighting-eye.

In other moments of a treatment session, (preferably the majority of a treatment session, e.g., at least 60% of the time, at least 70% of the time, and even at least 80% of the time) the subject looks at a predicted area of interest. During such moments, because the degraded area is colocated with the area of interest in the sighting-eye image, the subject's visual system likely perceives the area of interest of the amblyopic-eye image received from the amblyopic-eye. The use of the amblyopic-eye during such moments causes the subject's visual system to perceive images received from the amblyopic-eye, thereby treating the amblyopia, as discussed above.

Further, during moments when the subject looks at a predicted area of interest, the subject's visual system perceives areas around the predicted area of interest that are not degraded in the sighting-eye image with the peripheral vision of the amblyopic-eye and in some instances perceives these with the peripheral vision of both the amblyopic-eye and of the sighting-eye, thereby treating the amblyopia, as discussed above.

Thus, in some embodiments, the degraded area is not more than 50% of the area of the sighting-eye image and is colocated with a predicted area of interest in the received image. In some such embodiments, the preparing of the sighting-eye image further comprises:
identifying a predicted area of interest in the received image without reference to a measured gaze direction of the sighting-eye and/or the amblyopic-eye; and preparing the sighting-eye image from the received image so that the degraded area is colocated with the predicted area of interest.
   In some such embodiments, the balance of the area of the sighting-eye image that is not the degraded area is not-degraded.

In some embodiments, multiple predicted areas of interest are identified, but the sighting-eye image is prepared so that the degraded area is a single contiguous degraded area (e.g., colocated with a single predicted area of interest, or sufficiently large to be colocated with two or more predicted areas of interest). In some alternative embodiments, multiple predicted areas of interest are identified, and the sighting-eye image is prepared so that the degraded area is non-contiguous comprising at least two (two or more) separate degraded sub-areas, each sub-area colocated with a predicted area of interest. In some such embodiments, the degree and type of image-quality reduction in two degraded sub-areas is the same. In some such embodiments, the degree and/or type of image-quality reduction in two degraded sub-areas is different.

In some such embodiments, the degraded area of the sighting-eye image is not more than 40% of the area of the image, not more than 30%, not more than 20% and even not more than 10% of the area of the image. The size of a single contiguous degraded area or sub-area is preferably greater than 1.5 central degrees that corresponds to the typical size of human foveal vision, which size on the display screen is determined based on an estimated distance that the subject will be viewing the screen. For example, when the estimated distance of the subject from the screen is around 50 cm (e.g., when viewing a 15.4″ screen), 1.5 central degrees corresponds to a 2.8 mm diameter circle with a 6.2 mm² area. A standard 15.4″ (195 mm*345 mm) screen has a total area of 67000 mm², so that the degraded area is preferably greater than 0.001% of the screen and therefore of the sighting-eye image.

The shape of a contiguous degraded area or sub-area is any suitable shape, e.g., round, oval, square, rectangular, star-shaped, irregular. In some preferred embodiments, a degraded area or sub-area is circularly symmetric. In some alternate preferred embodiments, a degraded area or sub-area is the shape of a predicted area of interest.

In some embodiments, a contiguous degraded area or sub-area is the same size as a predicted area of interest, preferably the degraded area or sub-area sized and dimensioned to completely overlap the predicted area of interest so that none of the predicted area of interest can be seen un-degraded. In some embodiments, a contiguous degraded area or sub-area is larger than a identified area of interest in preferred embodiments positioned so that none of the identified area of interest can be seen un-degraded. In some embodiments, a contiguous degraded area or sub-area is smaller than a predicted area of interest so that some of the predicted area of interest can be seen un-degraded.

In some embodiments, a contiguous degraded area or sub-area is homogeneously degraded. In some embodiments, a degraded area or sub-area is heterogeneously degraded, that is a difference of degree of image-quality reduction in the area or sub-area. In some embodiments, heterogeneous degradation varies with a gradient, for example, a lesser degree of image-quality reduction near the periphery of a contiguous degraded area or sub-area that gradually increases towards the inside of the area or sub-area.

In such embodiments, the degree of image-quality reduction relative to the corresponding area in the received image is any suitable degree of image-quality reduction, In some embodiments, the degree of image-quality reduction of some or all of a given contiguous area or sub-area is 100%, that is to say, in such embodiments there is no visual information perceptible to a human in some or all of the degraded area or sub-area.

### Identifying a Predicted Area of Interest

A predicted area of interest in the received image is identified in any suitable way without reference to a measured gaze direction of the sighting-eye and/or the amblyopic-eye.

An area of interest is an area of the received image (e.g., an object depicted in the received image) that is expected to draw the gaze of a person viewing the received image. As is known in the art of cinematography, an areas of interest in an image is often not random, but carefully selected and designed. According to the method, any type of area of interest is identified. Examples of types of area of interest include area of interest that were previously identified, legible text, faces, outstanding picture elements, intentional area of interest and moving elements.

In some embodiments, an area of interest is identified by machine learning.

In some embodiments, the received image is a custom image configured for implementing the teachings herein and includes information (e.g., metadata) that identifies at least one area of interest. In such embodiments, identifying a predicted area of interest comprises reading the information identifying a predicted area of interest in a received image and/or the device is configured to read the information (e.g., the metadata) identifying an area of interest in a received image. In FIG. 5A is depicted a received image 22 and a corresponding sighting-eye image 22b when displayed. Received image 22 is a custom image for implementing the teachings herein and includes metadata that identifies a house that appears in image 22 as an area of interest 48 of received image 22. Corresponding sighting-eye image 22b includes a degraded area 46 colocated with area of interest 48. Degraded area 46 is homogeneously degraded, square, and slightly smaller than area of interest 48.

Additionally or alternatively, in some embodiments, identifying a predicted area of interest comprises identifying legible text in the received image as a predicted area of interest. A person having ordinary skill in the art of image analysis is able to configure a computer for automatic identification of legible text in an image. In FIG. 5B is depicted a received image 22 and a corresponding sighting-eye image 22b. Image 22 includes legible text which is identified as an area of interest 48 in the usual way of OCR (optical character recognition). Corresponding sighting-eye image 22b includes a degraded area 46 colocated with area of interest 48. Degraded area 46 is homogeneously 100% degraded, having no visual information perceptible to a human. The shape and size of degraded area 46 is the same as that of area of interest 48.

Additionally or alternatively, in some embodiments, identifying a predicted area of interest comprises identifying a face in the received image as a predicted area of interest. A person having ordinary skill in the art of image analysis is able to configure a computer for automatic identification of a face in an image. In FIG. 5C is depicted a received image 22 and a corresponding sighting-eye image 22b. Received image 22 includes a face which is identified as an area of interest 48 in the usual way of facial recognition technology. Corresponding sighting-eye image 22b includes a degraded area 46 colocated with area of interest 48. Degraded area 46 is circularly symmetric and is smaller than area of interest 48. Degraded area 46 is heterogeneously degraded, having a higher degree of image-quality reduction in the center and a lower degree of image-quality reduction in the periphery.

Additionally or alternatively, in some embodiments, identifying a predicted area of interest comprises identifying an outstanding picture element in the received image as a predicted area of interest. As known in the art of cinematography, outstanding picture elements are elements in an image that have characteristics that are substantially different from the rest of the image and are designed to draw a viewers gaze, for example, elements of particular sharpness, lighting or color. A person having ordinary skill in the art of image analysis is able to configure a computer processor for automatic identification of outstanding picture elements in an image. In FIG. 5D is depicted a received image 22 and a corresponding sighting-eye image 22b. Received image 22 includes an outstanding picture element, a sword that is bright and in sharp focus compared to other portion of the image, which is identified as an area of interest 48 in the usual way of image analysis (e.g., using one or more functions similar to rangefilt, stdfilt or entropyfilt known to a person having ordinary skill in the art of Matlab). Corresponding sighting-eye image 22b includes a degraded area 46 colocated with at area of interest 38. Degraded area 46 is circularly symmetric and is larger than area of interest 48. Degraded area 46 is homogeneously degraded.

Additionally or alternatively, in some embodiments, identifying a predicted area of interest comprises identifying an intentional area of interest in the received image as a predicted area of interest. As known in the art of cinematography, an artist can use well-known techniques to direct a viewers to an intentional area of interest, for example, by vignetting (changing the visual properties of areas around an object to frame an object or to direct a viewer's gaze to the object as an intentional area of interest, for example, adding linear elements/linear perspective that point at the object or using blur/brightness gradients). A person having ordinary skill in the art of image analysis is able to configure a computer processor for automatic identification of intentional areas of interest. In FIG. 5E is depicted a received image 22 and a corresponding sighting-eye image 22b. Received image 22 includes an intentional area of interest 48, the silhouette located at the hill crest, backlit by the full moon and pointed at by the sword, the stone walls, the winding road, the perspective and the roof slope which is identified as an area of interest 48 in the usual way of image analysis. Corresponding sighting-eye image 22b includes a degraded area 46 colocated with area of interest 48. Degraded area 46 is rectangular and is larger than area of interest 48. Degraded area 46 is homogeneously degraded.

Additionally or alternatively, in some embodiments, identifying a predicted area of interest comprises identifying an object in a video that is moving in a noticeable way (faster, slower, in an unusual direction compared to other objects) as a predicted area of interest which requires comparing multiple frames of the video. A person having ordinary skill in the art is able to implement well-known methods of moving-object detection in video to identify such a predicted area of interest.

In some embodiments, only a single type of predicted area of interest is identified, e.g., only legible text, only faces, only moving objects only outstanding objects. Accordingly, in some embodiments, a device is configured to identify only a single type of predicted area of interest in an image.

Alternately, in some embodiments two or more different types of areas of interest are identified. Accordingly, in some embodiments, a device is configured to identify two or more different types of predicted area of interest in an image.

Any suitable solution can be implemented when two or more predicted areas of interest are identified in a single received image.

In some embodiments, multiple predicted areas of interest are identified, but the sighting-eye image is prepared with only a single contiguous degraded area (e.g., colocated with a single predicted area of interest, or sufficiently large to be colocated with two or more predicted areas of interest).

In some embodiments, a degraded area is colocated with a first-identified predicted area of interest.

In some embodiments, a degraded area is colocated with a most centrally-located among two or more identified predicted areas of interest.

In some embodiments, a degraded area is colocated with the largest among two or more identified predicted areas of interest.

In some embodiments, a degraded area is colocated with a predicted area of interest among two or more identified predicted areas of interest according to a pre-determined hierarchy. For example, between any two predicted areas of interest that are identified of a different type, the predetermined hierarchy is a a face which is selected before text.

As noted above, in some embodiments when two or more predicted areas of interest are identified in a single received image the sighting-eye image is prepared with a non-contiguous degraded area comprising at least two separate degraded sub-areas, each sub-area colocated with a different identified predicted area of interest. In some such embodiments, the degree and type of image-quality reduction in two degraded sub-areas is the same. In some such embodiments, the degree and/or type of image-quality reduction in two degraded sub-areas is different.

In FIG. 5F is depicted a received image 22 and a corresponding sighting-eye image 22b. Received image 22 includes three different identified areas of interest 48a, 48b and 48c. Corresponding sighting-eye image 22b includes two different degraded sub-areas 46a and 46b. Degraded sub-area 46a is dimensioned to be colocated with both predicted areas of interest 48a and 48b. Degraded sub-area 46b is colocated with area of interest 48b.

Unless otherwise defined, all technical and scientific terms used herein have the same meaning as commonly understood by one of ordinary skill in the art to which the invention pertains. In case of conflict, the specification, including definitions, takes precedence.

As used herein, the terms “comprising”, “including”, “having” and grammatical variants thereof are to be taken as specifying the stated features, integers, steps or components but do not preclude the addition of one or more additional features, integers, steps, components or groups thereof.

As used herein, the indefinite articles “a” and “an” mean “at least one” or “one or more” unless the context clearly dictates otherwise.

As used herein, when a numerical value is preceded by the term “about”, the term “about” is intended to indicate +/−10%.

As used herein, a phrase in the form “A and/or B” means a selection from the group consisting of (A), (B) or (A and B). As used herein, a phrase in the form “at least one of A, B and C” means a selection from the group consisting of (A), (B), (C), (A and B), (A and C), (B and C) or (A and B and C).

Embodiments of methods and/or devices described herein may involve performing or completing selected tasks manually, automatically, or a combination thereof. Some methods and/or devices described herein are implemented with the use of components that comprise hardware, software, firmware or combinations thereof. In some embodiments, some components are general-purpose components such as general purpose computers or digital processors. In some embodiments, some components are dedicated or custom components such as circuits, integrated circuits or software.

For example, in some embodiments, some of an embodiment is implemented as a plurality of software instructions executed by a data processor, for example which is part of a general-purpose or custom computer. In some embodiments, the data processor or computer comprises volatile memory for storing instructions and/or data and/or a non-volatile storage, for example, a magnetic hard-disk and/or removable media, for storing instructions and/or data. In some embodiments, implementation includes a network connection. In some embodiments, implementation includes a user interface, generally comprising one or more of input devices (e.g., allowing input of commands and/or parameters) and output devices (e.g., allowing reporting parameters of operation and results.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

Section headings are used herein to ease understanding of the specification and should not be construed as necessarily limiting.

1. A device for treating amblyopia in a subject having a sighting-eye and an amblyopic-eye, comprising a computer functionally-associated with an electronic display screen, configured to:
i. receive a digital image;
ii. concurrently dichoptically display two different variants of a received image on said display screen so that each one of said two different variants is visible to only one eye of a subject,
an amblyopic-eye image to the amblyopic-eye of a subject; and
a sighting-eye image to the sighting-eye of a subject,
wherein said computer is further configured to:
prior to displaying an amblyopic-eye image, preparing the amblyopic-eye image for display from a received image; and
prior to the displaying of a sighting-eye image, preparing the sighting-eye image for display from a received image by degrading at least a portion of the received image to yield said sighting-eye image having a degraded area,
where said computer is configured so that a location of said degraded area is determined without reference to a determined gaze direction of a sighting-eye and/or of an amblyopic-eye of a subject.

2. The device of claim 1, devoid of an eye-tracker for determining a gaze direction of either the sighting-eye or the amblyopic-eye of a subject.

3. The device of claim 1, comprising an eye-tracker for determining a gaze direction of the sighting-eye and/or the amblyopic-eye of a subject.

4. The device of any one of claims 1 to 3, wherein said received image is a still image.

5. The device of any one of claims 1 to 3, wherein said received image is a frame from a video.

6. The device of any one of claims 1 to 5, wherein said amblyopic-eye image and said sighting-eye image constitute a stereoscopic image pair.

7. The device of any one of claims 1 to 6, wherein said concurrent displaying is simultaneous display of said amblyopic-eye image and said sighting-eye image on said display screen.

8. The device of any one of claims 1 to 7, wherein said concurrent displaying is alternatingly displaying said amblyopic-eye image and said sighting-eye image on said display screen at a rate of not less than 24 images per eye per second.

9. The device of any one of claims 1 to 8, wherein said preparing said amblyopic-eye image for display is such that said amblyopic-eye image is unaltered relative to said received image.

10. The device of any one of claims 1 to 8, said preparing said amblyopic-eye image for display comprises improving the image quality of at least part of the received image.

11. The device of any one of claims 1 to 10, wherein said preparing said sighting-eye image from said received image by degrading at least a portion of said received image to yield said sighting-eye image includes reducing the image quality of an area of said received image that corresponds to said degraded area to prepare said sighting-eye image.

12. The device of claim 11, wherein said reducing said image quality of said area of said received image that corresponds to said degraded area includes at least one member of the group consisting of: reducing contrast; reduced brightness; blurring; degraded color saturation; limited color pallete; and combinations thereof.

13. The device of any one of claims 1 to 12, wherein:
said display screen is a color screen;
said preparing said amblyopic-eye image for display is from the blue and green channels of said received image without the red channel of said received image; and
said preparing said sighting-eye image for display is from the red channel of said received image without the blue and green channels of said received image,
so that said amblyopic-eye image and said sighting-eye image constitute an anaglyph image pair.

14. The device of any one of claims 1 to 13, wherein said degraded area is at least 50% of the area of a sighting-eye image.

15. The device of claim 14, wherein a degree of image-quality reduction of said degraded area is not more than 90%.

16. The device of any one of claims 1 to 14, wherein said degraded area is not more than 50% of the area of a sighting-eye image and is colocated with a predicted area of interest in a received image, and wherein said computer is further configured to prepare a sighting-eye image by:
identifying a predicted area of interest in a received image; and
preparing the sighting-eye image from the received image such that the degraded area is colocated with the predicted area of interest.

17. The device of claim 16, wherein said computer is configured so that the balance of the area of said sighting-eye image that is not said degraded area is not-degraded.

18. The method of any one of claims 16 to 17, wherein said degraded area is a single contiguous degraded area.

19. The method of any one of claims 16 to 17, wherein said degraded area is a non-contiguous degraded area comprising at least two non-contiguous sub-areas.

20. The method of any one of claims 18 to 19, wherein a degree of image-quality reduction in at least a portion of a said contiguous area or in at least a portion of a sub-area of said at least two sub-areas is 100%.

21. The method of any one of claims 16 to 20, wherein said received image includes information that designates a portion of said received image as a predicted area of interest and said computer is configured so that said identifying an area of interest comprises reading said designating information.

22. The device of any one of claims 16 to 21, wherein the computer is configured so that said identifying a predicted area of interest comprises at least one member of the group consisting of:
identifying legible text in said received image as as a predicted area of interest;
identifying a face in said received image as as a predicted area of interest;
identifying an outstanding picture element in said received image as a predicted area of interest
identifying an intentional area of interest in said received image as a predicted area of interest; and
identifying an object that is moving in a noteworthy manner as a predicted area of interest.

23. A method for treating amblyopia in a subject having a sighting-eye and an amblyopic-eye, comprising:
a. receiving with a computer a digital image to be displayed to a subject;
b. concurrently dichoptically displaying two different variants of said received image on a single electronic display screen that is functionally-associated with said computer, one variant of said received image to each eye of the subject:
an amblyopic-eye image to the amblyopic-eye; and
a sighting-eye image to the sighting-eye,
wherein:
prior to said displaying of said amblyopic-eye image on said display screen, preparing said amblyopic-eye image for display from said received image; and
prior to said displaying of said sighting-eye image, preparing said sighting-eye image for display from said received image by degrading at least a portion of said received image to yield said sighting-eye image having a degraded area,
where a location of said degraded area in said sighting-eye image is determined without reference to a determined gaze direction of said sighting-eye and/or of said amblyopic-eye of the subject.

24. The method of claim 23, wherein said received image is a still image.

25. The method of any one of claims 23 to 24, wherein said received image is a frame from a video.

26. The method of any one of claims 23 to 25, wherein said amblyopic-eye image and said sighting-eye image constitute a stereoscopic image pair.

27. The method of any one of claims 23 to 26, wherein said concurrent displaying is simultaneous display of said amblyopic-eye image and said sighting-eye image on said display screen.

28. The method of any one of claims 23 to 27, wherein said concurrent displaying is alternatingly displaying said amblyopic-eye image and said sighting-eye image on said display screen at a rate of not less than 24 images per eye per second.

29. The method of any one of claims 23 to 28, wherein said preparing said amblyopic-eye image for display is such that said amblyopic-eye image is unaltered relative to said received image.

30. The method of any one of claims 23 to 28, wherein said preparing said amblyopic-eye image for display comprises improving the image quality of at least part of said received image.

31. The method of any one of claims 23 to 30, wherein said preparing said sighting-eye image from said received image by degrading at least a portion of said received image to yield said sighting-eye image having a degraded area includes reducing the image quality of an area of said received image that corresponds to said degraded area to prepare said sighting-eye image.

32. The method of claim 31, wherein said reducing said image quality of said area of said received image that corresponds to said degraded area includes at least one member of the group consisting of: reducing contrast; reduced brightness; blurring; degraded color saturation; limited color pallete; and combinations thereof.

33. The method of any one of claims 23 to 32, wherein:
said display screen is a color screen;
said preparing said amblyopic-eye image for display is such that the amblyopic-eye image is prepared from the blue and green channels of said received image without the red channel of said received image; and
said preparing said sighting-eye image for display is such that the sighting-eye image is prepared from the red channel of said received image without the blue and green channels of said received image,
so that said amblyopic-eye image and said sighting-eye image constitute an anaglyph pair.

34. The method of any one of claims 23 to 33, wherein said degraded area is at least 50% of the area of said sighting-eye image.

35. The method of claim 34, wherein a degree of image-quality reduction of said degraded area is not more than 90%.

36. The method of any one of claims 23 to 35, wherein said degraded area is not more than 50% of the area of the sighting-eye image and is colocated with a predicted area of interest in the received image, and said preparing of said sighting-eye image for display further comprises:
identifying a predicted area of interest in said received image; and
preparing said sighting-eye image from said received image so that said degraded area is colocated with said predicted area of interest.

37. The method of claim 36, wherein the balance of the area of said sighting-eye image that is not said degraded area is not-degraded.

38. The method of any one of claims 36 to 37, wherein said degraded area is a single contiguous degraded area.

39. The method of any one of claims 36 to 37, wherein said degraded area is a non-contiguous degraded area comprising at least two sub-areas.

40. The method of any one of claims 38 to 39, wherein a degree of image-quality reduction in at least a portion of a said contiguous area or in at least a portion of a sub-area of said at least two sub-areas is 100%.

41. The method of any one of claims 36 to 40, wherein said received image includes information that designates a portion of said received image as a predicted area of interest and said identifying an area of interest comprises reading said designating information.

42. The method of any one of claims 36 to 41, wherein said identifying a predicted area of interest comprises at least one member of the group consisting of:
identifying legible text in said received image as as a predicted area of interest;
identifying a face in said received image as as a predicted area of interest;
identifying an outstanding picture element in said received image as a predicted area of interest;
identifying an intentional area of interest in said received image as a predicted area of interest; and
identifying an object that is moving in a noteworthy manner as a predicted area of interest.

43. A device for treating amblyopia in a subject having a sighting-eye and an amblyopic-eye, comprising a computer functionally-associated with an electronic display screen, configured to implement the method of any one of claims to 21 to 42
